(19) United States
(12) Patent Application Publication
(10) Pub. No.: US 2016/0104257 A1
(43) Pub. Date: Apr. 14, 2016

(54) U-CHEF SERVICE SYSTEM USING TERMINAL, AND METHOD THEREOF

(71) Applicant: Man Bong LEE, Gyeonggi-do (KR)

(72) Inventor: Man Bong LEE, Seongnam (KR)

(21) Appl. No.: 14/891,378

(22) PCT Filed: May 7, 2014
(86) PCT No.: PCT/KR2014/004014

§ 371 Date: Nov. 16, 2015

(30) Foreign Application Priority Data
Mar. 11, 2014 (KR) 10-2014-0028416

(51) Int. Cl. G06Q 50/12; G06F 17/30; G06Q 30/06; G06Q 20/20; G06Q 20/32

(52) U.S. Cl. CPC G06Q 50/12; G06Q 20/202; G06Q 20/3276; G06Q 20/3278; G06Q 30/0635; G06F 17/30887

(57) ABSTRACT

Disclosed herein is a U-chef service method of a U-chef service system that processes an order in association with a POS terminal which processes an order in at least one shop in which an NFC or a QR code containing a URL address for a service is provided at a predetermined place and a customer terminal inside the shop, including: providing menu information previously prepared by a shop manager when the customer terminal accesses the server via the NFC or the QR code; transmitting order information to the POS terminal when the server receives a table number and a menu inputted by the customer terminal; transmitting the order information to a kitchen terminal; reporting when cooking is completed; and generating price information corresponding to the order information in accordance with operation of the shop manager and performing a payment process.

### CROSS-REFERENCE TO RELATED APPLICATION

This application claims priority to and the benefit of Korean Patent Application No. 10-2014-0028416 filed in the Korean Intellectual Property Office on Mar. 11, 2014, the entire contents of which are incorporated herein by reference.

### BACKGROUND OF THE INVENTION

(a) Field of the Invention

The present invention relates to a U-chef service system using a terminal, and a method thereof. More particularly, the present inventing relates to a U-chef service system using a terminal and a method thereof that enables a user to access menu books of shops through a web browser of a user terminal by using a QR code or an NFC, and then search the menu books and perform an order and payment.

(b) Description of the Related Art

In general, various electronic devices such as a mobile phone and a smart phone have been manufactured and widely popularized according to development of electronic communication technology.

The smartphone has been widely popularized. Further, many users have performed various work such as calls, e-mails, and wireless internet access by using the smartphone.

The latest smartphone has technological merits that the user freely configures the mobile phone like his/her own PC by directly downloading and installing an application. Courtesy of evolution of a mobile phone concept, a variety of applications based on the smart phone have been briskly developed and released in the business market.

Meanwhile, a plurality of shops such as restaurants, fast food shops, and coffee shops have a partly automated ordering system on the basis of a POS terminal so as to expedite aggressively flooding orders. For the best example, an order identification device called a “vibration bell” is provided to a customer, and then an ordered product is accordingly delivered to the customer via the order identification device as soon as the ordered product is prepared to be served.

However, the time required for handling the order at the shop does not decrease. For example, when the customer places an order at the coffee shop, the customer firstly selects a type of coffee for the order. However, the order is not completed by selecting the type of the coffee. Mostly, the customer should forward an exact number of the coffee to an employee of the coffee shop. Further, an exact size of the coffee (e.g., small or regular) should be additionally forwarded to the employee. Otherwise, the order of coffee is not properly arranged. When the coffee shop promotes and provides an event to the customer, the customer should participate in the event by answering a question from the employee. Further, when the customer possesses an associated card or a discount card, the customer shows the associated card or the discount card to the employee. In the case of cash payment, the customer decides whether to receive a cash receipt or not. As necessary, identification information to issue the cash receipt should be forwarded to the employee. Since such a complicated order procedure is continuously repeated to the customer, the time required for ordering the coffee does not decrease.

A method for partly handling the order procedure via the mobile phone of the customer may be proposed in order to solve the above-described problems. However, since the mobile phone connecting to a mobile communications network does not support a local service that is basically limited at a specific space, an order processing system via the mobile phone has a drawback that complicated procedures for certification and identification are required to provide the customer with the local service.

In order to overcome the above-mentioned problems, as a conventional art, an order handling system at the shop, a POS terminal, and a program therefor are disclosed in Korean Patent Laid-Open Publication No. 2011-0129330.

However, the conventional art still has a drawback that the application is installed, thereby causing inconvenience to the user.

In the meantime, a high cost is required for a shop manager to implement a website. Furthermore, currently it is not conveniently performed to apply modified factors of the menu book to the web site.

The above information disclosed in this Background section is only to enhance the understanding of the background of the invention and therefore it may contain information that does not form the prior art that is already known in this country to a person of ordinary skill in the art.

### SUMMARY OF THE INVENTION

The present invention has been made in an effort to provide a U-chef service system using a terminal in which a point of sale (POS) terminal for processing an order in a shop and a customer smartphone may be mutually connected such that if the customer smartphone contacts a QR code, an NFC, or the like, the menus of the shop may be automatically provided and an order and a payment may be processed, and to provide a method thereof.

In addition, the present invention has been made in an effort to provide a U-chef service system using a terminal and a method thereof in which a customer can make an order regardless of time and place.

Further, the present invention has been made in an effort to provide a U-chef service system using a terminal and a method thereof in which a shop manager can freely configure a new e-menu book or change an existing e-menu book.

An exemplary embodiment of the present invention provides a U-chef service method of a U-chef service system that processes an order in association with a point of sale (POS) terminal which processes an order in at least one shop in which an NFC or a QR code containing a URL address for a service is provided at a predetermined place and a customer terminal inside the shop, including: providing, by a server, menu information previously prepared by a shop manager when the customer terminal accesses the server via the NFC or the QR code; transmitting, by the server, order information to the POS terminal when the server receives a table number and a menu inputted by the customer terminal; transmitting, by the POS terminal, the order information to a kitchen terminal; reporting, by the kitchen terminal, when cooking is completed; and generating, by the POS terminal, price information corresponding to the order information in accordance with operation of the shop manager and performing a payment process, wherein the providing of the menu information previously prepared by the shop manager may include providing the menu information in a language corresponding to that of the customer terminal.

In case of prepayment by the customer terminal, the order information may be selected, the payment process may be performed, and payment information may be transmitted to the POS terminal.

Another embodiment of the present invention provides a U-chef service method of a U-chef service system that processes an order in association with a point of sale (POS) terminal which processes an order in at least one shop in which an NFC or a QR code containing a URL address for a service is provided at a predetermined place and a customer terminal inside the shop, including: providing, by a server, menu information previously prepared by a shop manager when the customer terminal accesses the server via the NFC or the QR code; transmitting, by the server, order information to the POS terminal when the server receives a menu ordered by the customer terminal; generating, by the POS terminal, price information corresponding to the order information in accordance with operation of the shop manager and performing a payment process; transmitting, by the POS terminal, the order information to a kitchen terminal; and reporting, by the kitchen terminal, when cooking is completed.

A further embodiment of the present invention provides a U-chef service method of a U-chef service system that processes an order in association with a point of sale (POS) terminal which processes an order in at least one shop in which an NFC or a QR code containing a URL address for a service is provided at a predetermined place and a customer terminal inside the shop, including: providing, by a server, menu information previously prepared by a shop manager when the customer terminal accesses the server via the NFC or the QR code; inputting order information to the POS terminal depending on operation of the shop manager; transmitting, by the POS terminal, the order information to the kitchen terminal; reporting, by the kitchen terminal, when cooking is completed; when the customer wants to pay, receiving, by the server, price information corresponding to the order information from order information in accordance with the request of the customer terminal and transmitting the price information to the customer terminal; and performing, by the customer terminal, a payment process.

A further embodiment of the present invention provides a U-chef service system that processes an order in association with a point of sale (POS) terminal which processes an order in at least one shop in which an NFC or a QR code containing a URL address for a service is provided at a predetermined place and a customer terminal inside the shop, including: a database unit which stores information on the shop at which the POS terminal is installed and menu information and membership information corresponding to the shop information; and a server which provides menu information previously prepared by a shop manager, receives a menu, and transmits order information to the POS terminal when the customer terminal contacts the NFC or the QR code to be connected to the server.

The POS terminal may receive the order information from the server, transmit the received menu information to a kitchen terminal, generate price information corresponding to the order information in accordance with the operation of the shop manager, and perform a payment process.

The database unit may include: a shop information DB which stores information of the POS terminal and the information of the shop at which the POS terminal is installed; a menu information DB which stores the menu information corresponding to the shop information; and a member DB which stores membership information, wherein the server may include: an order processing unit which provides the menu information previously prepared by the shop manager, receives a table number and a menu, and transmits the order information to the POS terminal when the customer terminal contacts the NFC or the QR code to be connected to the server; and a menu writing unit which provides information for writing the menu when the shop manager terminal is connected, and stores a written menu in the menu information DB, wherein the information for writing the menu may include menu image information, price information, and an order button.

According to the embodiments of the present invention, a point of sale (POS) terminal for processing an order in a shop and a customer smartphone may be mutually connected such that if the customer smartphone contacts a QR code, an NFC, or the like, the menus of the shop may be automatically provided and an order and a payment may be processed.

According to the embodiments of the present invention, a customer can make an order regardless of time and place.

According to the embodiments of the present invention, a shop manager can freely configure a new e-menu book or change an existing e-menu book.

### BRIEF DESCRIPTION OF THE DRAWINGS

FIG. 1 illustrates a schematic block diagram of a U-chef service system according to an exemplary embodiment of the present invention.

FIG. 2 illustrates a schematic block diagram of a customer terminal of FIG. 1.

FIG. 3 illustrates an operation flowchart of a U-chef service method according to an exemplary embodiment of the present invention.

FIGS. 4 to 9 are drawings illustrating examples of a web screen provided by the U-chef service system according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the whole of specification, In addition, unless explicitly described to the contrary, the word “comprise” and variations such as “comprises” or “comprising” will be understood to imply the inclusion of stated elements but not the exclusion of any other elements

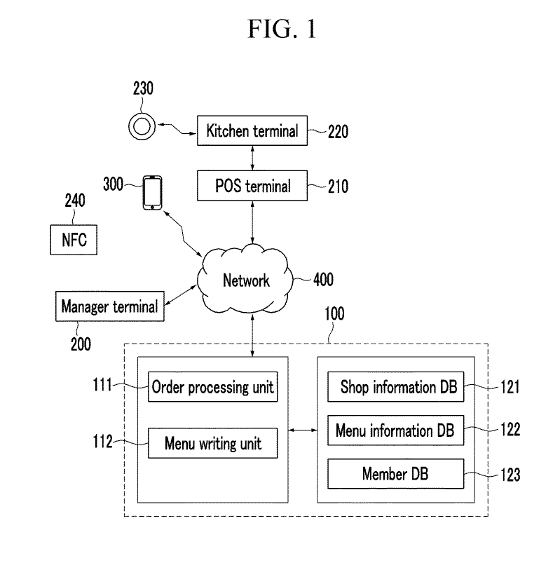

FIG. 1 illustrates a schematic block diagram of a U-chef service system according to an exemplary embodiment of the present invention.

Referring to FIG. 1, a U-chef service system 100 according to an exemplary embodiment of the present invention which processes an order in association with a point of sale (POS) terminal 210 which processes the order in at least one shop in which an NFC or a QR code 240 containing a URL address for a service is provided at a predetermined place and a customer terminal 300 inside the shop, includes:

a database unit 120 that stores information on a shop at which the POS terminal 210 is installed, menu information corresponding to the shop information, and membership information; and

a server 110 that provides the menu information previously prepared by a shop manager, receives a table number and a menu, and transmits order information to the POS terminal 210, when the customer terminal 300 contacts the server via the NFC or the QR code 240 to be connected to the server 110.

The POS terminal 210 receives the order information from the server 110, transmits the received order information to a kitchen terminal 220, and generates price information corresponding to the order information in accordance with operation of the shop manager and processes payment.

The database unit 120 includes:

a shop information DB 121 which stores information of the POS terminal 240 and information of the shop at which the POS terminal 240 is installed;

a menu information DB 122 which stores menu information corresponding to the shop information; and

a member DB 123 which stores the membership information.

The server 110 includes:

an order processing unit 111 which provides the menu information previously prepared by the shop manager, receives the table number and the menu, and transmits the order information to the POS terminal 210, when the customer terminal 300 contacts the server via the NFC or the QR code 240 to be connected thereto; and

a menu writing unit 112 which provides information for writing the menu when a shop manager terminal 200 is connected thereto, and stores the written menu in the menu information DB 122.

The information for writing the menu includes menu image information, the price information, and an order button.

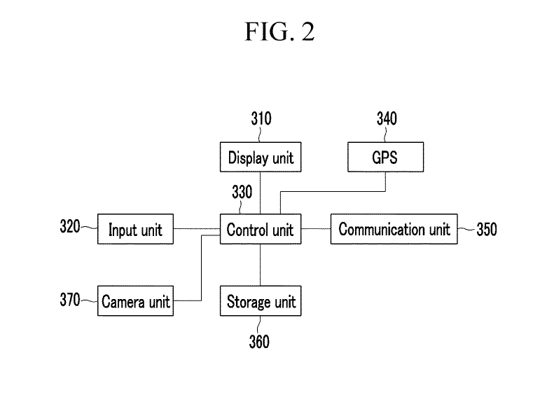

FIG. 2 illustrates a schematic block diagram of a terminal according to an exemplary embodiment of the present invention.

Referring to FIG. 2, a terminal according to the exemplary embodiment of the present invention includes: an input unit 320, a GPS unit 340, a storage unit 360, a camera unit 370, a communication unit 350, a control unit 330, and a display unit 310.

The input unit 320 may include an input device such as a touch panel and a key pad, which are used for the user to select a menu.

The GPS unit 340 generates and outputs its own position information by receiving GPS signals from at least two GPS satellites. As necessary, position information provided by a mobile communication company may be used without the GPS unit.

The storage unit 360 stores downloaded contents with respect to wallpaper.

As necessary, photograph information photographed by the camera unit may be stored.

The camera unit 370 photographs an image of the outside depending on selection of the input unit 320.

The control unit 330 displays a menu screen provided by the server 110 on the display unit 310, and transmits the menu information selected by the input unit 320 to the server 110.

The communication unit 350 transmits and receives information depending on control of the control unit 330, and may use wireless internet such as Wi-Fi, 3G, 4G, etc., and wireless other communication networks.

Operation of the U-chef service system will now be described in detail.

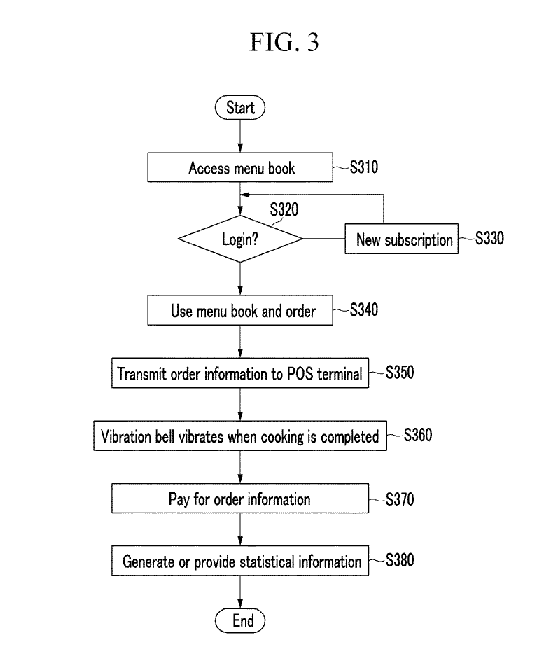

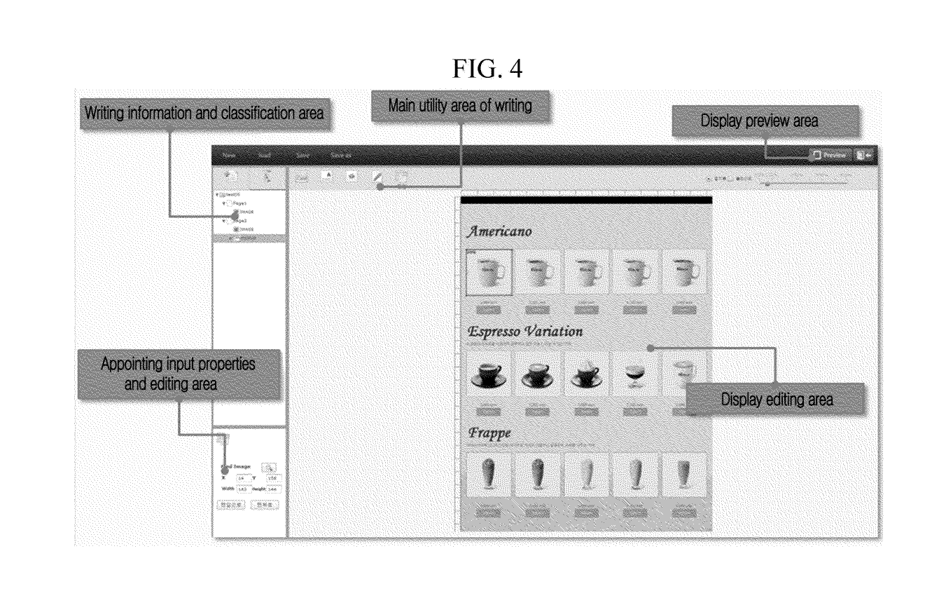

FIG. 3 illustrates an operation flowchart of a U-chef service method according to an exemplary embodiment of the present invention, and FIGS. 4 to 9 are drawings illustrating examples of a web screen provided by the U-chef service system according to the exemplary embodiment of the present invention.

First, the user accesses the sever 110, and may sign up for a membership via the network 400 by using the user terminal 300 or other terminals. The user may sign up for a membership offline, and use the server 110 as a non-member. Further, when the user signs up for the membership, personal information including gender, age, ID, and a password may be inputted.

Then, the server 110 completes the membership registration process by receiving and storing the personal information including the gender and the age, the ID, and the password in the member DB 123 of the database unit 120.

In the meantime, the shop manager accesses a web page of the server 110 by using the shop manager terminal 200 and selects menu writing. When the shop manager selects the menu writing of his/her own shop, the menu writing unit 112 provides a menu writing screen as shown in FIG. 4.

Then, the shop manager generates menu book data by selecting, inserting, and disposing a plurality of pieces of information such as the menu image information, the price information, and the order button.

Accordingly, when the customer visits the shop or accesses the shop via the NFC or the QR code 240 provided at the shop or a predetermined place by using the customer terminal 300 outside, the customer terminal 300 connects with the server 110 by operating a web browser thereof.

Then, the server 110 performs a login process at step S310. In this case, as necessary, the customer may place an order via member login or in a non-member mode.

When a non-member wants to sign up for membership, the sever 110 accepts the membership at step S330.

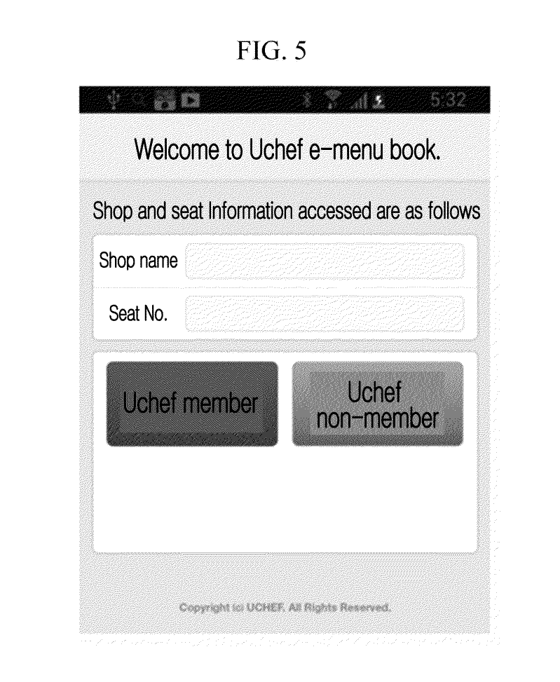

Meanwhile, when the customer turns out to be the member at step S320 or the non-member places an order, the server 110 receives a shop name and a seat number as shown in FIG. 5. As necessary, the input procedure may be omitted by inserting the shop information and the seat number in the QR code.

When the shop name and the seat number are inputted or the shop name and the seat number are inputted in advance via the QR code, the order processing unit 111 provides the menu information corresponding to the NFC or the QR code 240, which is previously written by the shop manager.

The shop manager writes and stores the menu information in various languages, such that the server may provide the menu corresponding to the language information of the customer terminal.

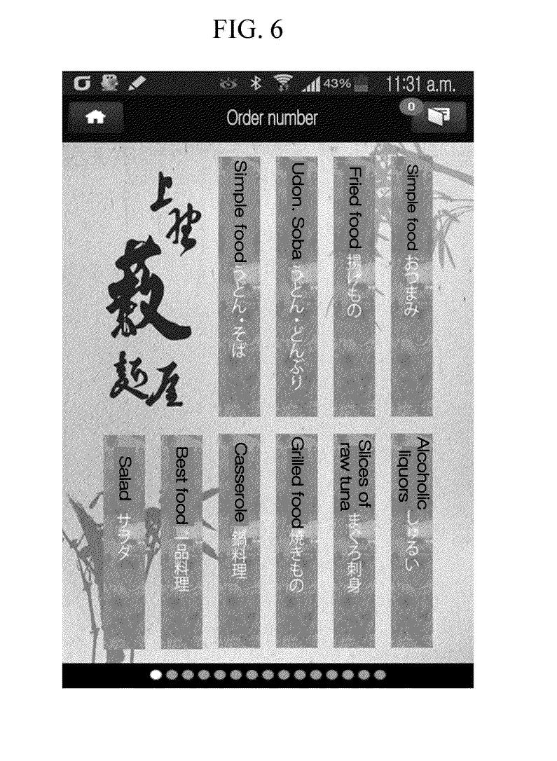

In this case, the menu information may be formed as that of FIG. 6 or the like, and it may be modified depending on the writing of the shop manager. In addition, the menu information may be modified at any time.

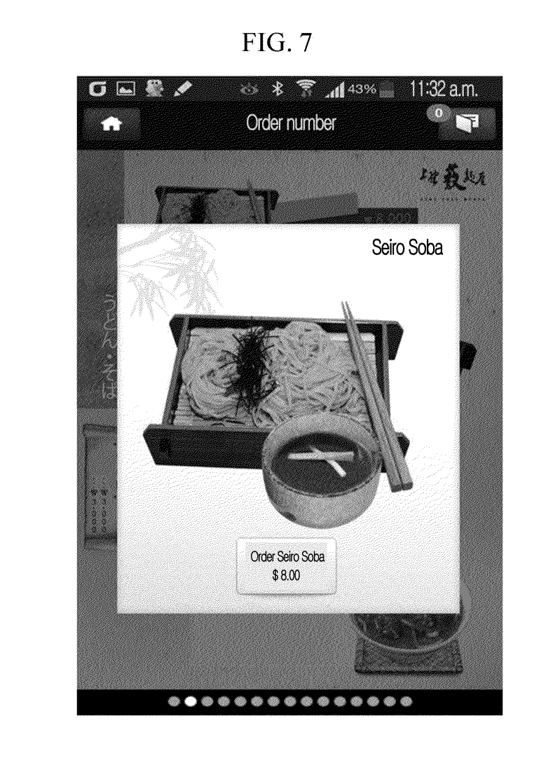

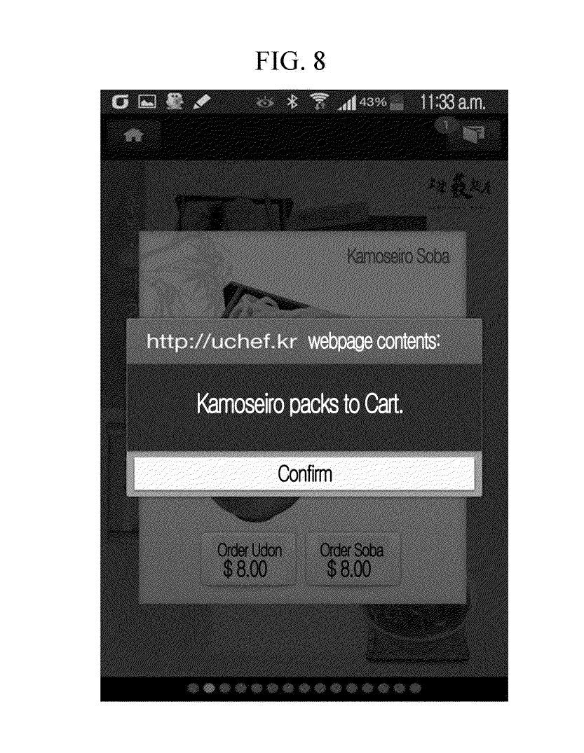

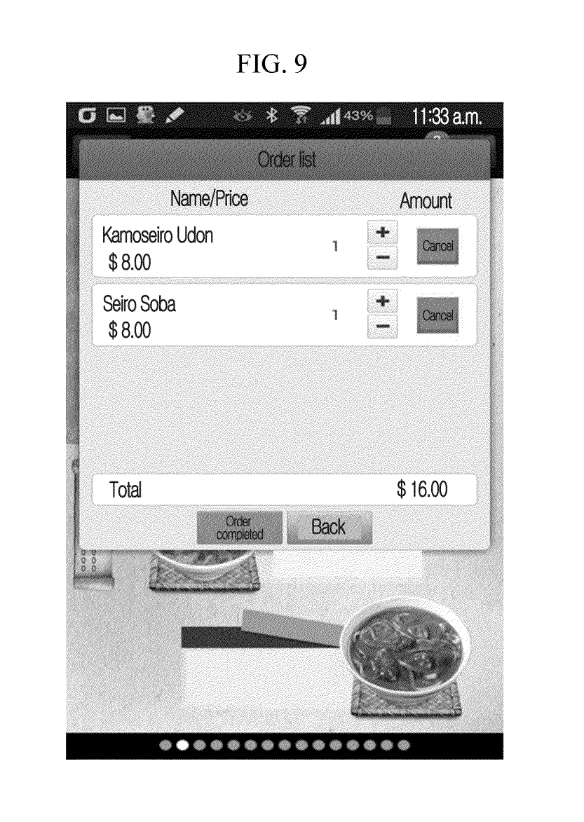

Price is confirmed by selecting a product as shown in FIG. 7, and the order is finally completed by confirming a menu list as shown in FIG. 9 after selecting the menu as shown in FIG. 8 at step S340.

In this case, in case of prepayment, the customer terminal performs a mobile payment process before the order information is transmitted to the POS terminal. When the prepayment is successfully completed, the order information is transmitted to the POS terminal.

Then, the order processing unit 111 of the server 110 receives the menu from the customer terminal 300, and transmits the menu information to the shop POS terminal 210 in which the menu information is described at step S350.

The POS terminal 210 receives and stores the order information, and transmits the order information to the kitchen terminal 220.

After the above-mentioned processes, workers in the kitchen cook a dish in accordance with the order information received by the kitchen terminal 220, and then serve the dish to the customer. When the dish on the order list is completely cooked, a vibration signal for the “vibration bell” may be outputted by controlling the kitchen terminal, thereby vibrating the “vibration bell”. As necessary, a number may be displayed on a display device instead of the “vibration bell”.

Then, the customer takes food or coffee he/she ordered and eats or drinks it.

In case of a deferred payment, when the customer wants to pay, the price information corresponding to the order information is transmitted from the POS terminal 210 to the customer terminal 300 in accordance with the request of the customer terminal 300, and the customer terminal 300 performs the payment process at step S370.

The order information and payment information are transmitted to the server 110, and are stored in the database unit 120.

When the shop manager requires statistical information from the server 110 as necessary, the server 110 provides sale information of the corresponding shop. In this case, the server 110 may edit the statistical information in advance by using the order information and the payment information.

Further, as necessary, even if the seat number is not transmitted from the customer terminal 300, the server 110 allows the menu to be selected and an order to be placed in advance with only the shop information.

Therefore, the customer may place the order and complete the payment in advance, thereby saving time when the customer visits and waits at the shop.

Additionally, as necessary, the time when the customer waits for the ordered food may be significantly saved by including cooking time information in the menu information and performing the order and the payment in advance. Further, the customer may have a meal or take the meal out on arrival.

The server may provide a rough map or directions corresponding to the shop by receiving the position information from the customer terminal.

In the above-mentioned process, as necessary, the customer may place an order verbally, and the shop manager himself/herself may directly input the payment information by using the POS terminal 210.

In this case, when the customer wants to pay, the price information corresponding to the order information is transmitted from the POS terminal to the server 110 in accordance with the request of the customer terminal 300, and when the server 110 transmits the price information to the customer terminal 300, the customer terminal 300 performs the payment process.

According to the exemplary embodiment of the present invention, when the customer simply contacts the server via the QR code or the NFC, the menu may be automatically provided and the order may be conveniently placed in association with the POS terminal processing the order at the shop and the customer smart phone.

In addition, the customer may place an order at any time and anywhere.

Further, the shop manager may freely write a new e-menu book or modify the e-menu book.

The exemplary embodiments of the present invention described above are not implemented only through a system and a method, but, on the contrary, are enabled to be implemented through a program which realizes functions corresponding to configuration of the exemplary embodiments of the present invention or through a recording medium at which the program is recorded. Accordingly, those skilled in the art may easily implement the exemplary embodiments of the present invention with reference to the above-mentioned description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A U-chef service method of a U-chef service system that processes an order in association with a point of sale (POS) terminal which processes an order in at least one shop in which an NFC or a QR code containing a URL address for a service is provided at a predetermined place and a customer terminal inside the shop, comprising:
providing, by a server, menu information previously prepared by a shop manager when the customer terminal accesses the server via the NFC or the QR code;
transmitting, by the server, order information to the POS terminal when the server receives a table number and a menu inputted by the customer terminal;
transmitting, by the POS terminal, the order information to a kitchen terminal;
reporting, by the kitchen terminal, when cooking is completed; and
generating, by the POS terminal, price information corresponding to the order information in accordance with operation of the shop manager and performing a payment process,
wherein the providing of the menu information previously prepared by the shop manager includes providing the menu information in a language corresponding to that of the customer terminal.

2. The U-chef service method of claim 1, wherein in case of prepayment, by the customer terminal, the order information is selected, the payment process is performed, and payment information is transmitted to the POS terminal.

3. A U-chef service method of a U-chef service system that processes an order in association with a point of sale (POS) terminal which processes an order in at least one shop in which an NFC or a QR code containing a URL address for a service is provided at a predetermined place and a customer terminal inside the shop, comprising:
providing, by a server, menu information previously prepared by a shop manager when the customer terminal accesses the server via the NFC or the QR code;
transmitting, by the server, order information to the POS terminal when the server receives a menu ordered by the customer terminal;
generating, by the POS terminal, price information corresponding to the order information in accordance with operation of the shop manager and performing a payment process;
transmitting, by the POS terminal, the order information to a kitchen terminal; and
reporting, by the kitchen terminal, when cooking is completed.

4. A U-chef service system that processes an order in association with a point of sale (POS) terminal which processes an order in at least one shop in which an NFC or a QR code containing a URL address for a service is provided at a predetermined place and a customer terminal inside the shop, comprising:
a database unit which stores information on the shop at which the POS terminal is installed and menu information and membership information corresponding to the shop information; and
a server which provides menu information previously prepared by a shop manager, receives a menu, and transmits order information to the POS terminal when the customer terminal contacts the server via the NFC or the QR code to be connected to the server.

5. The U-chef service system of claim 4, wherein the POS terminal receives the order information from the server, transmits the received menu information to a kitchen terminal, generates price information corresponding to the order information in accordance with the operation of the shop manager, and performs a payment process.

6. The U-chef service system of claim 5, wherein the database unit includes:
a shop information DB which stores information of the POS terminal and the information of the shop at which the POS terminal is installed;
a menu information DB which stores the menu information corresponding to the shop information; and
a member DB which stores membership information,
wherein the server includes:
an order processing unit which provides the menu information previously prepared by the shop manager, receives a table number and a menu, and transmits the order information to the POS terminal when the customer terminal contacts the server via the NFC or the QR code to be connected to the server; and
a menu writing unit which provides information for writing the menu when the shop manager terminal is connected, and stores a written menu in the menu information DB,
wherein the information for writing the menu includes menu image information, price information, and an order button.

7. A U-chef service method of a U-chef service system that processes an order in association with a point of sale (POS) terminal which processes an order in at least one shop in which an NFC or a QR code containing a URL address for a service is provided at a predetermined place and a customer terminal inside the shop, comprising:
providing, by a server, menu information previously prepared by a shop manager when the customer terminal accesses the server via the NFC or the QR code;
inputting order information to the POS terminal depending on operation of the shop manager;
transmitting, by the POS terminal, the order information to the kitchen terminal;
reporting, by the kitchen terminal, when cooking is completed;
when the customer wants to pay, receiving, by the server, price information corresponding to the order information from order information in accordance with the request of the customer terminal and transmitting the price information to the customer terminal; and
performing, by the customer terminal, a payment process.
